(19) United States
(12) Patent Application Publication
(10) Pub. No.: US 2005/0222524 A1
(43) Pub. Date: Oct. 6, 2005

(54) Apparatus and method for applying variable localized pressure to the human body

(76) Inventors: Stuart Fielding, Morris Plains, NJ (US); John W. Stein, Allentown, PA (US)

Correspondence Address: NIXON & VANDERHYE, PC, 901 NORTH GLEBE ROAD, 11TH FLOOR, ARLINGTON, VA, 22203, US

(21) Appl. No.: 11/080,435

(22) Filed: Mar. 16, 2005

Related U.S. Application Data
(60) Provisional application No. 60/553,563, filed on Mar. 17, 2004.

(51) Int. Cl. A61H 23/00

(52) U.S. Cl. 601/98; 601/101; 601/105; 601/108; 606/239; 606/238

(57) ABSTRACT

A method and apparatus for applying a variable localized pressure to a selected portion of the human spine to modify human behavior or treat a human condition or ailment. A flexible and resilient pressure member is brought into engagement with the spine portion, and a mechanism is connected to the pressure member to support it in engagement with the spine portion and to create reciprocatory movement of the pressure member in a predetermined timed sequence to effect the variable localized pressure on the spine portion.

### CROSS-REFERENCES TO RELATED APPLICATIONS

This application claims priority from Provisional Patent Application No. 60/553,563, filed Mar. 17, 2004, and entitled “APPARATUS AND METHOD FOR TREATING HUMAN CONDITIONS AND AILMENTS” which is incorporated herein by reference in its entirety.

### BACKGROUND OF THE INVENTION

1. Field of the Invention

The present invention relates to apparatus and methods for applying variable localized pressure to the human body and, more particularly, to such apparatus and methods for applying pressure against a portion of the human spine to treat various human conditions and ailments, and modify human behavior.

2. Prior Art

U.S. Pat. No. 5,205,238 discloses methods and apparatus for applying controlled stress to animals by mounting an apparatus on a body part of an animal, such as the tail, and applying variable stress such as a tail pinch to modify animal behavior. This patent does not apply to the treatment of human conditions or ailments.

U.S. Pat. No. 6,168,573, issued to the named inventors herein, discloses methods and apparatus for applying controlled stress in the form of variable localized pressure to a portion of the human spine to treat various types of human ailments and conditions, such as pain, Parkinson's disease, depressive disorders, stroke and other conditions. The use of such methods and apparatus has also been found to cause modifications in human behavior such as increase in appetite, a change in sexual behavior, increased blood flow to the brain, and/or an increase of neurotransmitters, including dopamine, serotonin and norepinephrine. The disclosure of Pat. No. 6,168,573 is incorporated herein by reference in its entirety.

The present invention is directed to new and improved apparatus and methods for applying variable localized pressure to the human spine, in general accordance with the methods set forth in U.S. Pat. No. 6,168,573.

### SUMMARY OF THE INVENTION

The apparatus of the present invention comprises a flexible and resilient pressure member of any suitable external shape, such as curved, which is brought into contact with an appropriate portion of the human spine to apply pressure thereto in a predetermined timed sequence for the purpose of modifying human behavior or treating human conditions or ailments.

The pressure member may be movably mounted on any suitable type of support or apparatus, such as a portable unit that can be removably mounted on a person so that the pressure member is in contact with the appropriate portion of the human spine, or a fixed unit that is mounted on a chair, bed or the like. Also, the pressure member may be moved in a predetermined timed sequence against the human spine by any suitable type of operating apparatus, such as mechanical, hydraulic, pneumatic, electronic or a combination of same.

The apparatus of the present invention can be used to modify human behavior and to treat various human conditions and ailments, some of which are set forth hereinafter.

Iron Deficiency Anemia, General Anemia And Sickle Cell Anemia

The use of the present apparatus increases the oxygen carrying capacity of the blood owing to an increase in hemoglobin.

Asthma

The use of the present apparatus may result in bronchial passage dilation due to activation of adrenergic (β2) receptors, which results in reduction of symptoms such as coughing, wheezing, shortness of breath.

Angina

The use of the present apparatus may increase coronary blood flow and oxygen to the heart to reduce pain.

Hypertension

The use of the present apparatus relaxes vascular smooth muscle to decrease peripheral resistance in the blood vessels and thereby decrease blood pressure.

Cachexia (Wasting Disorder In Elderly) And Anorexia Nervosa

The use of the present apparatus results in an increase in appetite by activating the hypothalamic feeding center in the brain and decreasing the activity of the satiety center.

Bulimia Nervosa and Obesity

The use of the present apparatus before eating reduces the volume of food intake because of an increase in serotonegic activity.

Diabetes (Type II)

The use of the present apparatus increases levels of insulin due to Beta 2 (Adrenergic) receptor activation to reduce symptoms such as frequent urination, dry mouth or the like.

Muscle Tissue Growth And Growth Hormones

The use of the present apparatus may elevate endogenous anabolic steroids, when used in combination with strength training, and may increase the number of unbound receptor sites resulting in greater muscle mass. It also may result in increased bone density, lean tissue, a decrease in fat, and an improvement in mood and motivation.

Parkinson's Disease

The use of the present apparatus increases the activity in the dopaminergic system to aid in slowing the degenerative course in Parkinson patients by reducing symptoms such as decreased tremors, decreased rigidity and decrease in gait abnormalities.

Alzheimer's Disease

The use of the present apparatus increases acetylcholine activity to slow the progression of the disease and improve cognitive functioning.

Stroke

The use of the present apparatus results in an increase in cerebral blood flow to prevent the spread of necrosis and therefore reduce the amount of neurological deficit. There is an increase in brain utilization of glucose and oxygen to the affected area to thereby reduce symptoms such as numbness, weakness or sudden severe headache.

Back Pain, Headache and Post-Operative Pain

The use of the present apparatus results in reduction of pain and anxiety associated with various conditions.

Arthritis

The use of the present apparatus results in partial relief from symptoms such as stiffness, redness along with anxiety reduction.

Bipolar Disorder

The use of the present apparatus produces hormonal balance, thereby reducing mood swings and stabilizing behavior.

Depression

The use of the present apparatus helps to restore the balance of the serotonergic and noradrenergic system, thereby reducing symptomatology.

Obsessive/Compulsive Disorder

The use of the present apparatus helps to restore the balance of serotonergic and dopaminergic systems, thereby reducing symptomatology.

Schizophrenia

The use of the present apparatus helps to decrease the dopaminergic activity through an increase in serotonin, thereby resulting in a decrease in positive (florid) symptoms.

Anxiety Disorder

The use of the present apparatus results in a reduction in anxiety and reduced symptoms such as trembling, twitching, or excessive startle reflex.

Panic Disorder and Post-Traumatic Stress Disorder

The use of the present apparatus results in an increase in 5-HT (serotonin) activity to decrease anxiety and stress.

Attention Deficit/Hyperactivity Disorder

The use of the present apparatus results in an increase in activity of the noradrenergic and dopaminergic systems to result in increased focus and attention span.

Anti-Social Personality Disorder

Although there is no specific treatment for this disorder, the use of the present apparatus may reduce symptoms such as anxiety and stress.

Absence Seizure, Generalized Seizure, Simple Partial Seizure and Complex Partial Seizure

The use of the present apparatus reduces excess neuronal discharge to thereby reduce the frequency and intensity of seizures.

Sexual Dysfunction

The use of the present apparatus may increase libido owing to increased blood flow and norepinephrine activity to result in improved performance.

Insomnia

The use of the present apparatus may result in sleep promotion and less frequent awakening during the night.

Alcohol and Cocaine Addiction

The use of the present apparatus may make alcohol or drug ingestion unpleasant and thereby reduce its reinforcing qualities.

The foregoing and other features, aspects and advantages of the apparatus of the present invention will become more apparent from the following detailed description when taken in conjunction with the accompanying drawings.

### BRIEF DESCRIPTION OF THE DRAWINGS

FIG. 1 is a schematic side elevational view, with parts broken away, of a first embodiment of the apparatus of the present invention;

FIG. 2 is a side elevational view of a second embodiment of the apparatus of the present invention;

FIG. 3 is a perspective view, with parts broken away, of a third embodiment of the apparatus of the present invention;

FIG. 4 is a perspective view, with parts broken away, of a fourth embodiment of the apparatus of the present invention;

FIG. 5 is a front elevational schematic view of a fifth embodiment of the apparatus of the present invention;

FIG. 6 is a side elevational view of apparatus like that shown in FIG. 5;

FIG. 7 is a front elevational view of a sixth embodiment of the apparatus of the present invention in a portable form;

FIG. 8 is a perspective view of a seventh embodiment of the apparatus of the present invention mounted on a chair or other support;

FIG. 9 is a schematic view of an eighth embodiment of the apparatus of the present invention with a hydraulic operating system; and

FIG. 10 is a ninth embodiment of the apparatus of the present invention with a pneumatic operating system.

### DETAILED DESCRIPTION OF THE INVENTION

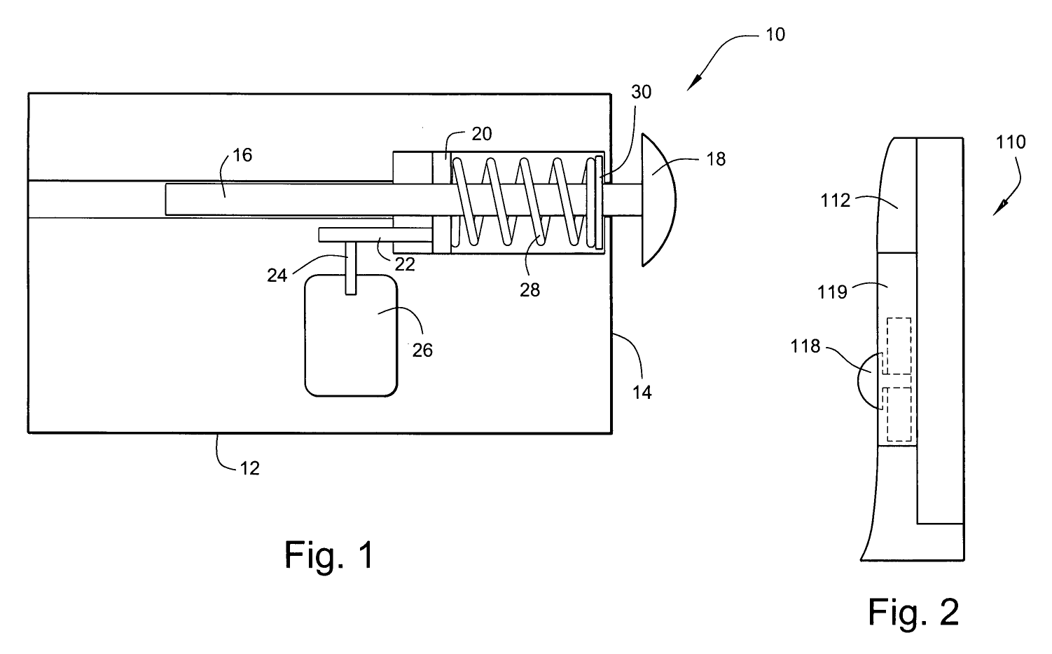

FIG. 1 illustrates schematically a first embodiment of the apparatus 10 of the present invention which comprises a housing 12 of any suitable construction having a front surface 14. A plunger 16 of any suitable constructions is sidably mounted on the housing 12 and extends outwardly through the front surface 14. A pressure member 18 formed of a flexible and resilient material and of any suitable shape is mounted on the outer end of the plunger 16. As an illustrative example, the pressure member 18 may be in the form of a bulbous member having a curved outer surface for engagement with an appropriate portion of the human spine, and may have an outer diameter or width of approximately 2.5 inches and a thickness of approximately 1.25 inches. The pressure member 18 may be formed of rubber, synthetic rubber or any other suitable plastic or other material.

A cam follower member 20 is secured to the plunger 16 and is in engagement with a cam member 22 eccentrically mounted on the shaft 24 of a suitable motor 26 which may be a DC high torque motor. A spring 28 of any suitable type, such as a coil spring, is mounted between the cam follower member 20 and a stop member such as a washer 30 mounted on the housing 12. The spring 28 serves to urge the cam follower member 20 into slidable engagement with the outer surface of the cam member 22.

In operation, rotation of the shaft 24 by the motor 26 rotates the eccentric cam member 22 to move the cam follower member 20 laterally against the force of the spring 28 to effect reciprocating motion of the plunger 16 and the pressure member 18 on the outer end thereof. This reciprocating motion of the pressure member 18 applies variable localized pressure to the adjacent portion of the human spine (not shown) or a selected body portion.

The motor 26 may be operated at any suitable or desired speed to effect a desired speed of reciprocation of the pressure member 18 and an appropriate variable localized pressure to the adjacent portion of the human spine (not shown) in engagement therewith. As an illustrative example, the plunger 16 and pressure member 18 may be reciprocated through a distance of approximately ¼ of an inch inwardly and outwardly relative to the front portion 14 of the housing 12 in a timed sequence of approximately 0.5 seconds in each position.

It is noted that the housing 12 and the components of the apparatus of the present invention may be formed of any suitable materials.

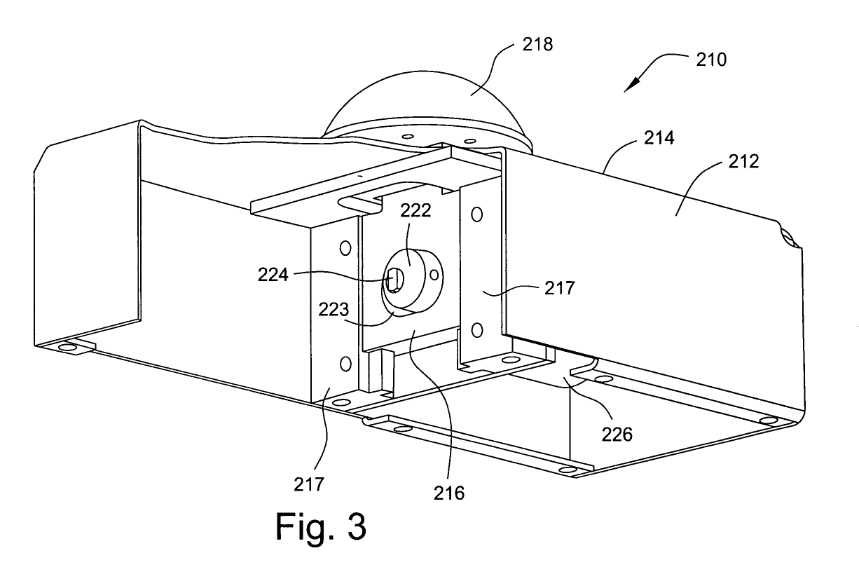

FIG. 2 illustrates a second embodiment of the apparatus 110 of the present invention wherein the pressure member 118 is mounted on a support 119 that is removably mounted on the housing 112. In this manner, the pressure member 118 may be easily replaced by another suitable pressure member (not shown) having a different construction and/or shape for desired applications.

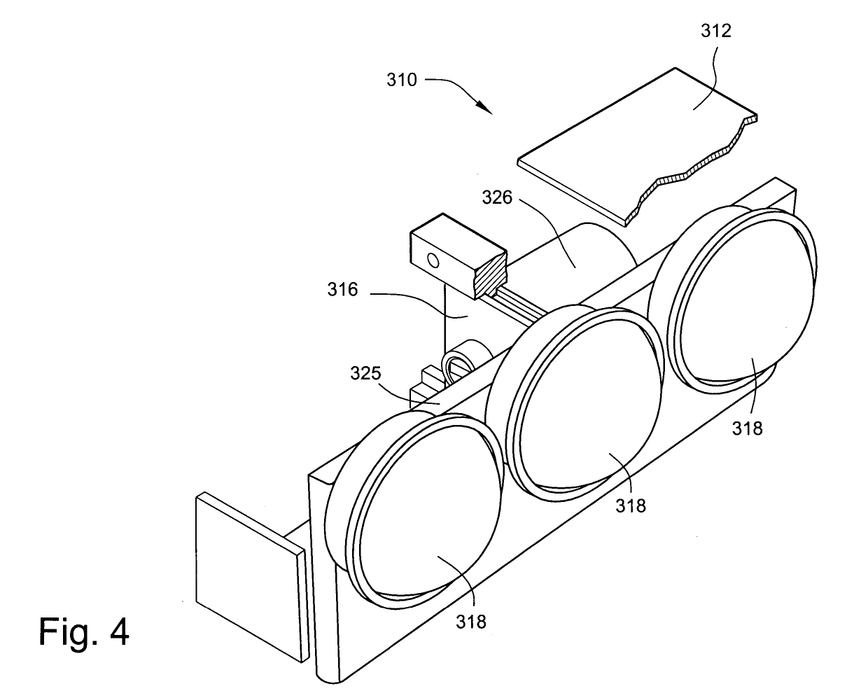

FIG. 3 illustrates a third embodiment of the apparatus 210 of the present invention comprising a housing 212 with a motor 226 mounted therein and having a shaft 224 on which a cam member 222 is eccentrically mounted. In this embodiment, the cam member 22 is rotatable within an opening 223 in the plunger 216 having the pressure member 218 mounted on the outer end thereof. The plunger 216 is slidably mounted on elongated support members 217 secured to the housing 212.

In the operation of the apparatus 210, the actuation of the motor 226 serves to rotate the shaft 224 and eccentric cam member 222 to cause a reciprocating motion of the plunger 216 relative to the supports 217 and a corresponding reciprocating motion of the pressure member 218 relative to the front portion 214 of the housing 212.

In accordance with the present invention, the housing 212 may be portable and may be provided with one or more handles (not shown) for facilitating its movement, and also may be provided with a suitable device such a belt or harness (not shown) for removably mounting the apparatus 210 on a person such that the pressure member 218 is in engagement with the appropriate spinal portion of that person, such as that illustrated in U.S. Pat. No. 6,168,573.

FIG. 4 illustrates a fourth embodiment of the apparatus 310 of the present invention that is similar to the apparatus 210 shown in FIG. 3. In the apparatus of FIG. 4, a support member 325 supports three pressure members 318 on the outer surface of the housing 312 and is connected to the plunger 316 for reciprocating motion that results from the operation of the motor 326.

In accordance with the present invention, any suitable number of pressure members 318 may be used and they may be of any suitable shape and/or construction.

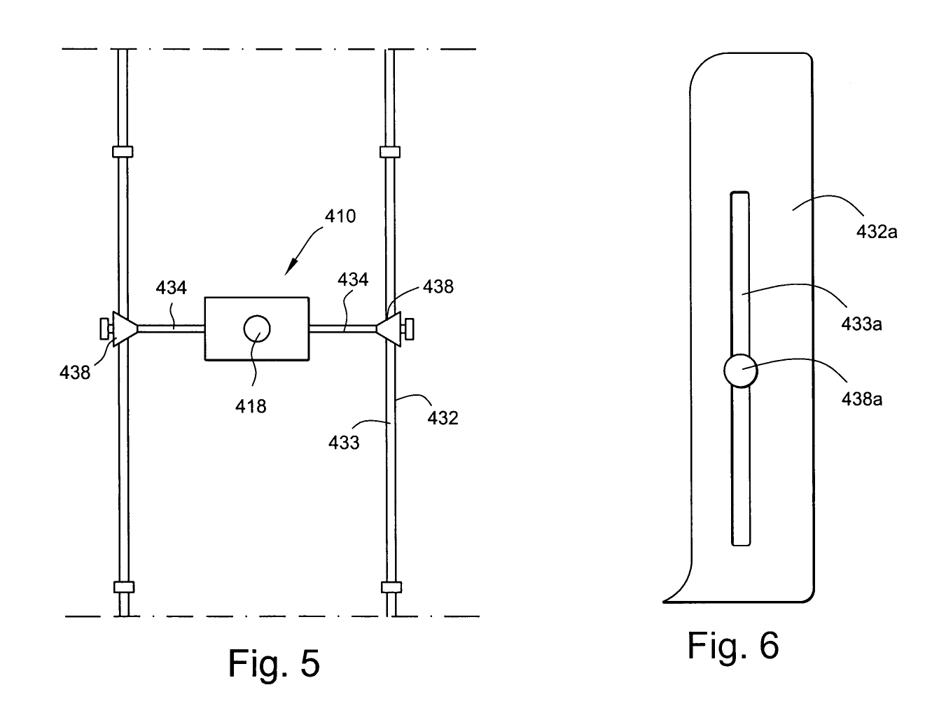

FIGS. 5 and 6 illustrate a fifth embodiment of the apparatus of the present invention wherein the apparatus 410 having the pressure member 418 on the front thereof is movably mounted on a suitable support frame 432 or housing 432a, so that it can be easily positioned for engagement of the pressure member 418 with an appropriate portion of the human spine (not shown).

As an illustrative example, the frame 432 or housing 432a may be provided with aligned, elongated slots 433 or 433a on both sides thereof in which the ends of arms 434 connected to the apparatus 410 are slidably mounted. A suitable locking device 438 or 438a may be mounted on the outer end of each arm 434 for engagement with the adjacent portion of the frame 432 or housing 432a to removably lock the arms in a desired position relative to the frame 432 or housing 432a.

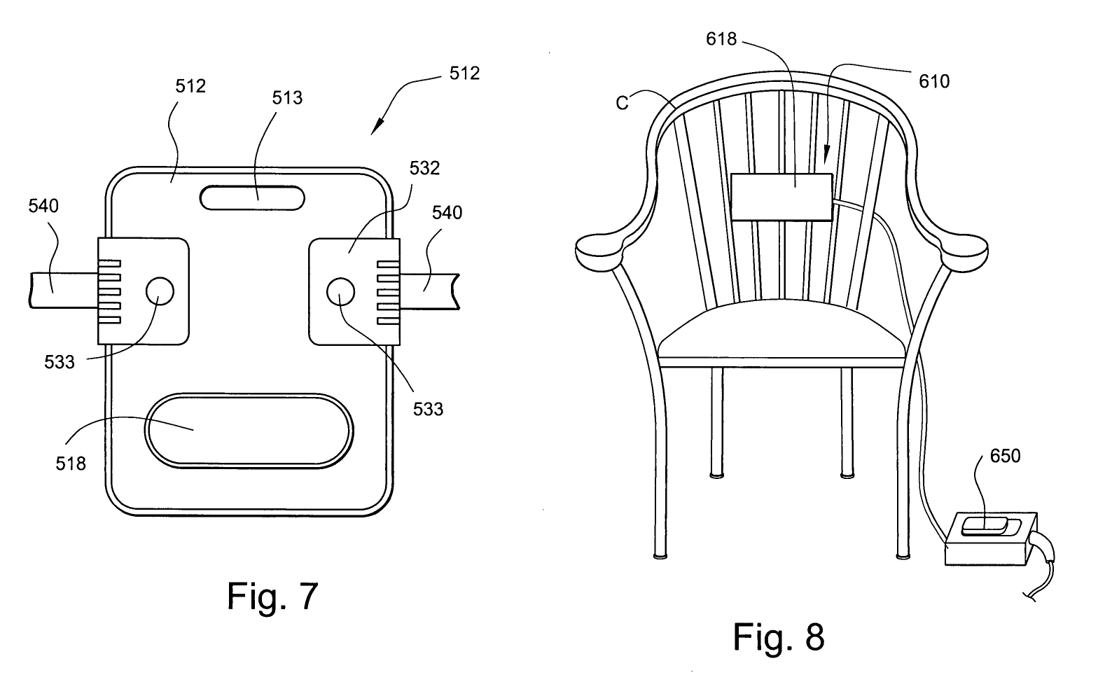

FIG. 7 illustrates a sixth embodiment of the present invention wherein the housing 512 of the apparatus 510 is portable and is provided with an elongated pressure member 518 on the outer surface thereof. The housing 512 is provided with a handle portion 513 and is movably mounted on a support frame 532. The housing 512 may be of any suitable construction and the frame 532 may be provided with a belt 540 or any other suitable support for removably mounting the apparatus 510 on a person such that the pressure member 518 is in engagement with the appropriate portion of the spine of that person. The frame 532 may be provided with suitable locking members 533 for retaining the housing 512 in a desired position relative thereto.

FIG. 8 illustrates a seventh embodiment of the present invention wherein the pressure applying apparatus 610 is mounted either fixedly or adjustably on the back portion of a chair C or other suitable support. The pressure apparatus 610 may be constructed such that it is operable by a remote control unit 650 of any suitable construction that may be held by the person sitting in the chair with his or her spinal portion in engagement with the pressure member or members 618 of the apparatus 610.

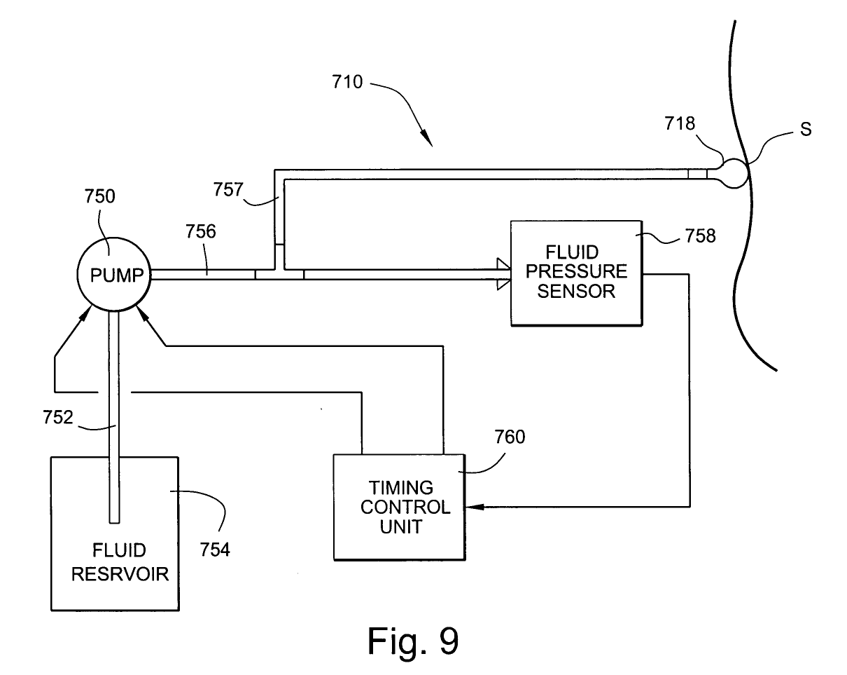

FIG. 9 illustrates schematically an eighth embodiment of the apparatus 710 of the present invention wherein the reciprocating motion of the pressure member 718 in engagement with the human spinal portion S is effected by a hydraulic operating system. In this embodiment, the pressure member 718 may be in the form of an inflatable, flexible and resilient bulb member, or alternatively, may be in the form of a pressure member that is slidably mounted for reciprocal movement on a housing (not shown) such as the pressure members 18 and 218 shown in FIGS. 1 and 3, respectively.

The apparatus 710 comprises a pump 750 that is connected by a fluid line 752 to a fluid reservoir 754. The pump is also connected by a fluid line 756 to a fluid pressure sensor 758 that is electrically or otherwise connected to an electronic, computer or other timing control unit 760 for the control of forward or reverse movement of the pump 750. A fluid line 757 connects the fluid line 756 with the pressure member 718.

In operation, the pump 750 is operated for forward motion by the control unit 760 to pressurize the fluid lines 756 and 757 to inflate or move outwardly the pressure member 718 in engagement with the spinal portion S. When a predetermined pressure is reached in the lines 756 and 757, the fluid pressure sensor 758 sends an appropriate signal to the control unit 760 which, after a predetermined time period, effects reverse movement of the pump to reduce the pressure in the fluid lines 756 and 757 to cause deflation or inward movement of the pressure member 718 relative to the adjacent spinal portion S. After a further predetermined time period, the control unit again actuates forward movement of the pump 750 to repeat the cycle. In this manner, the pressure member 718 applies a variable localized pressure to the adjacent portion of the spinal column S of the person being treated.

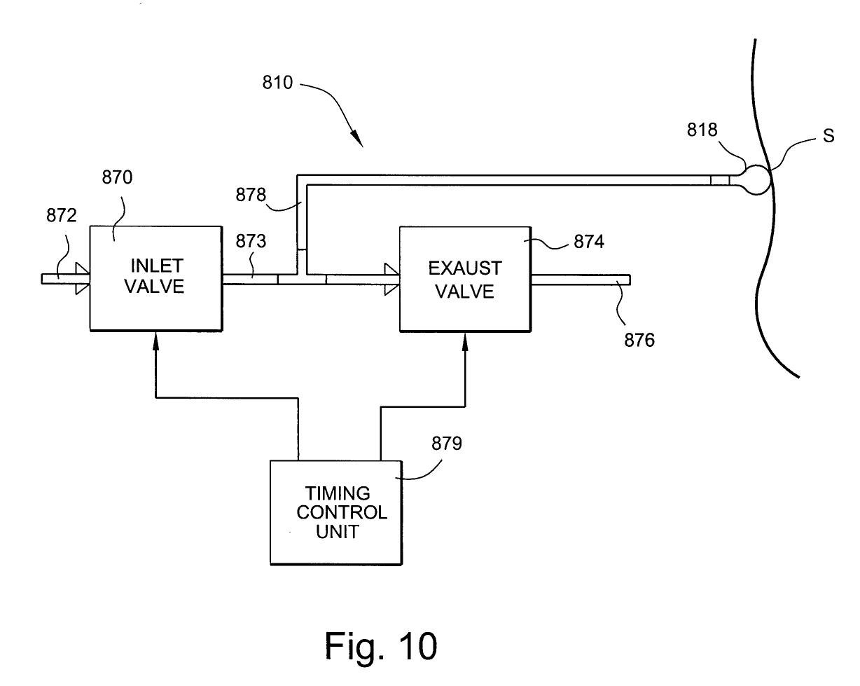

FIG. 10 illustrates a ninth embodiment of the apparatus of the present invention wherein the pressure apparatus 810 comprises a pressure member 818 of flexible and resilient material that may be inflated or moved against the adjacent spinal portion S of the person to be treated. In this embodiment, the movement of the pressure member 818 is effected pneumatically and the apparatus 810 comprises an inlet valve 870 that is connected by an air line 872 to a suitable pressurized air supply (not shown). The outlet end of the inlet valve 870 is connected to an air line 873 that is connected to the inlet of an exhaust valve 874 that has an outlet connected to an air line 876 that exhausts to the atmosphere. The pressure member 818 is connected by an air line 878 to the air line 873. The inlet valve 870 and exhaust valve 874 are both operatively connected to an electronic, computer or other timing control unit 879 which, at predetermined sequences, opens the inlet valve 870 and closes the exhaust valve 874 to inflate or move outwardly the pressure member 818 against the adjacent spinal portion S and, thereafter, closes the inlet valve 870 and opens the exhaust valve 874 to cause inward movement of the pressure member 818 and reduce pressure on the adjacent spinal portion S. In the manner, the pressure member 818 is reciprocated to create a predetermined localized pressure on the adjacent portion of the spinal portion S of the person to be treated.

From the foregoing description, it will be readily seen that the pressure member for engaging the appropriate spinal portion of a person to be treated may be of any suitable construction, such as those disclosed herein, and may be operated by any suitable type of actuating apparatus, such as those disclosed herein. As an illustrative example, the pressure member may be brought into engagement with a portion of the lower spine at the L5-S1 vertebral level.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims,

1. Apparatus for applying a variable localized pressure to a selected portion of the human spine to modify human behavior or treat a human condition, said apparatus comprising:
a flexible and resilient pressure member for engagement with the human spine portion; and
a mechanism for supporting said pressure member in engagement with the human spine portion and creating reciprocatory movement thereof in a predetermined timed sequence to effect the variable localized pressure on the human spine portion.

2. The apparatus of claim 1 wherein said pressure member is slidably mounted on a support for reciprocatory movement.

3. The apparatus of claim 2 wherein said support is a housing and said pressure member is positioned on the outside of said housing.

4. The apparatus of claim 3 wherein said pressure member is mounted on a plunger slidably mounted within said housing, and a motor is operatively connected to said plunger to effect reciprocatory movement of said plunger and said pressure member.

5. The apparatus of claim 4 wherein said motor is connected to said plunger by an eccentric cam member that is rotatable by said motor.

6. The apparatus of claim 5 wherein said plunger has a cam follower member thereon in slidable engagement with said cam member.

7. The apparatus of claim 6 wherein a spring is positioned between said cam follower member and said housing to urge said cam follower member into engagement with said cam member.

8. The apparatus of claim 5 wherein said plunger has an opening therethrough and said eccentric cam member is positioned in said opening for engagement with the interior surface thereof.

9. The apparatus of claim 3 wherein said housing is movably mounted on a support frame for selective positioning of said pressure member.

10. The apparatus of claim 9 wherein said housing is slidably mounted on said support frame and comprises a device for releasably locking it in a selected position on said support frame.

11. The apparatus of claim 3 wherein said housing is portable and comprises a support device for removably supporting it on a person so that said pressure member is in engagement with a selected spine portion of the person.

12. The apparatus of claim 11 wherein said housing comprises a handle portion to facilitate movement thereof.

13. The apparatus of claim 11 wherein said support device is a belt or harness.

14. The apparatus of claim 3 wherein said pressure member is removably mounted on said housing.

15. The apparatus of claim 1 wherein said pressure member is of a bulbous shape with a curved outer surface.

16. The apparatus of claim 15 wherein said pressure member has a flat inner surface.

17. The apparatus of claim 15 wherein said pressure member comprises a plurality of pressure members.

18. The apparatus of claim 15 wherein said pressure member is circular in shape.

19. The apparatus of claim 15 wherein said pressure member is elongated in shape.

20. The apparatus of claim 1 wherein said pressure member is inflatable.

21. The apparatus of claim 1 wherein said mechanism is mounted on the back of a chair.

22. The apparatus of claim 21 wherein a remote control unit is operatively connected to said mechanism for operation thereof by a person sitting in the chair.

23. The apparatus of claim 21 wherein said mechanism is adjustably mounted on said chair.

24. The apparatus of claim 1 wherein said mechanism comprises a mechanical operating system.

25. The apparatus of claim 1 wherein said mechanism comprises a hydraulic operating system.

26. The apparatus of claim 25 wherein said hydraulic operating system comprises a pump connected by fluid lines to a liquid reservoir, a pressure sensor and said pressure member, and a control unit is connected to said pump and said pressure sensor for controlling the operation of said pump and reciprocation of said pressure member.

27. The apparatus of claim 1 wherein said mechanism comprises a pneumatic operating system.

28. The apparatus of claim 27 wherein said pneumatic operating system comprises an inlet valve connected by air lines to a pressured air supply and to said pressure member, an exhaust valve connected by air lines to said inlet valve and said pressure member, and a control unit connected to said inlet valve and said exhaust valve to control the alternate opening and closing thereof to apply periodic air pressure to said pressure member to effect the reciprocation thereof.

29. A method for applying a variable localized pressure to a selected portion of the human spine to modify human behavior or treat a human condition, said method comprising:
contacting the spine portion with a flexible and resilient pressure member, and
reciprocating said pressure member relative to the spine portion in a predetermined sequence to apply the variable localized pressure thereto.

30. The method of claim 29 wherein said pressure member is movably mounted on an adjustable support for reciprocal motion relative thereto.

31. The method of claim 29 wherein said pressure member is an inflatable, bulbous member, and is alternatively inflated and deflated to generate the reciprocation thereof.

32. The method of claim 31 wherein said pressure member is inflated and deflated by a hydraulic operating system.

33. The method of claim 31 wherein said pressure member is inflated and deflated by a pneumatic operating system.

34. The method of claim 29 wherein said pressure member is a bulbous member with a curved outer surface.

35. The method of claim 29 wherein said pressure member is mounted for reciprocal motion on a portable housing.

36. The method of claim 29 wherein said pressure member is mounted for reciprocal motion on a housing mounted on the back of a chair.

37. The method of claim 29 wherein the reciprocation of said pressure member is controlled by a mechanism that is constructed for remote control.

38. The method of claim 29 wherein the spine portion is in the lower spine at the L5 to S1 vertebral levels.

39. The method of claim 29 wherein the pressure member is mounted on a portable support that is removably mounted on the person to be treated.

40. The method of claim 34 wherein said pressure member comprises a plurality of bulbous members with curved outer surfaces.

41. A method of causing a change in the body of a human being, comprising the steps of:
a. positioning a pressure actuator against a portion of the human spine; and
b. selectively applying pressure to the spine using said actuator, wherein the change is an increase in the brain of epinephrine, glutamate, GABA (gama-amino-butyric-acid), endorphins, acetylcholine, protein and/or melatonin.

42. A method of treating an abnormal condition in humans, comprising the steps of:
a. positioning a pressure actuator against a portion of the human spine; and
b. selectively applying pressure to the spine using said actuator, wherein the abnormal condition is asthma, angina, hypertension, Type II diabetes, peripheral diabetic neuropathy, anorexia nervosa, obesity, bulimia nervosa, Alzheimer's, back pain, headache, arthritic pain, chronic pain, post-operative pain, bipolar disorder, obsessive-compulsive disorder, general anxiety disorder, panic disorder, post-traumatic stress disorder, attention deficit disorder, anti-social personality disorder, absence seizure, generalized seizure, simple partial seizure, complex partial seizure, insomnia, alcohol addiction, cocaine addiction, fybromyalgia, spastic (cerebral palsy), choreoathetoid cerebral palsy, ataxic cerebral palsy, mixed cerebral palsy, multiple sclerosis and/or spinal cord injury.

43. A method of causing a change in the body of a human being, comprising the steps of:
a. positioning a pressure actuator against a portion of the human spine; and
b. selectively applying pressure to the spine using said actuator wherein the change is hormones, amino acid, an increase in milk production in nursing mothers, muscle tissue growth and elevation of endogenous anabolic steroids and/or an increase in endogenous growth hormones.
